(19) United States
(12) Patent Application Publication
(10) Pub. No.: US 2013/0104716 A1
(43) Pub. Date: May 2, 2013

(54) HOLDING SHEET AND CUTTING APPARATUS PROVIDED THEREWITH

(71) Applicant: Brother Kogyo Kabushiki Kaisha, Nagoya-Shi (JP)

(72) Inventors: Katsuhisa Hasegawa, Kasugai-shi (JP); Yasuhiko Kawaguchi, Nagoya-shi (JP); Tomoyasu Niizeki, Ichinomiya-shi (JP); Masahiko Nagai, Nagoya-shi (JP); Yoshinori Nakamura, Toyohashi-shi (JP)

(73) Assignee: BROTHER KOGYO KABUSHIKI KAISHA, Nagoya-Shi (JP)

(21) Appl. No.: 13/626,156

(22) Filed: Sep. 25, 2012

(30) Foreign Application Priority Data
Oct. 31, 2011 (JP) 2011-238560

(51) Int. Cl. B26D 7/01; B32B 3/24; B32B 7/12

(52) U.S. Cl. 83/451; 428/137; 428/136; 428/40.1

(57) ABSTRACT

A holding sheet which is set to a cutting apparatus cutting an object to be cut includes a sheet member comprising a flat plate-shaped member and an adhesive portion located on an area of the sheet member located a predetermined distance inside an outer edge of the sheet member. The adhesive portion holds the object so that the object is removable therefrom. The sheet member has a plurality of holes which is defined formed through the sheet member so as to encompass the adhesive portion.

### CROSS-REFERENCE TO RELATED APPLICATIONS

This application is based upon and claims the benefit of priority from the prior Japanese Patent Application No. 2011-238560 filed on Oct. 31, 2011, the entire contents of which are incorporated herein by reference.

### BACKGROUND

1. Technical Field

The present disclosure, relates to a cutting apparatus in which a cutting blade and an object to be cut are moved relative to each other so that the object is cut, and a holding sheet set in the cutting apparatus.

2. Related Art

There has conventionally been known a cutting plotter which automatically cuts a sheet such as paper. The paper is affixed to a base material serving as a holding sheet having an adhesive layer on a surface thereof. The cutting plotter includes a drive mechanism having a driving roller and a pinch roller both of which are disposed one above the other and hold right, and left ends of the base material therebetween so that the base material is moved in a first direction. A carriage having a cutting blade is moved in a second direction perpendicular to the first direction so that the paper is cut by the cutting blade.

The base material is formed of a plastic sheet, for example and has a surface on which are formed reference marks or a grid graticule. In this cutting plotter, when affixed to the adhesive layer of the base material, the paper is placed according to the reference marks or edges of the paper are placed along the grid graticule so that the paper is positioned.

In use of the above-described cutting plotter, the user needs to cut the paper with scissors into such a size that the paper fits into an area inside both edges of the base material. More specifically, the paper needs to be cut into a suitable size according to the base material. In this case, the user obtains, by measurement, a size of the paper complying with the base material. The user then draws an outline on the paper with a pen on the basis of the obtained size and cuts the paper along the outline, with the result chat the cutting work is troublesome.

### SUMMARY

Therefore, an object of the disclosure is to provide a holding sheet which can easily match the object to a suitable size according to the holding sheet and a cutting apparatus provided with the holding sheet.

The present disclosure provides a holding sheet which is set to a cutting apparatus cutting an object to be cut, comprising a sheet member comprising a flat plate-shaped member; and an adhesive portion provided on an area of the sheet member located a predetermined distance inside an outer edge of the sheet member, the adhesive portion holding the object so that the object is removable therefrom, wherein the sheet member has a plurality of holes which is formed therethrough so as to encompass the adhesive portion.

The disclosure also provides a cutting apparatus which includes a cutting blade cutting an object to be cut, comprising a holding sheet settable to the cutting apparatus, the holding sheet including a sheet member comprising a flat plate-shaped member; and an adhesive portion provided on an area of the sheet member located a predetermined distance inside an outer edge of the sheet member, the adhesive portion holding the object so that the object is removable therefrom, wherein the sheet member has a plurality of holes which is formed therethrough so as to encompass the adhesive portion.

### BRIEF DESCRIPTION OF THE DRAWINGS

In the accompanying drawings:

FIG. 1 is a perspective view of the cutting apparatus according to one embodiment, together with a holding sheet, showing an inner structure of the cutting apparatus;

FIG. 2 is an enlarged, side view of a distal end of the cutter and its vicinity during cutting;

FIG. 3 is a perspective view of the holding sheet and the object which is overlapped with the holding sheet;

FIGS. 4A and 4B are plan views of the holding sheet, and the object with marks having been put thereto respectively;

FIGS. 5A and 5B are views similar to FIGS. 4A and 4B, showing a second embodiment, respectively;

FIG. 6A is a view similar to FIG. 4A, showing a third embodiment;

FIGS. 6B and 6C are plan views of the object, showing the case where all the marks are put to the object in twice;

FIG. 7 is a view similar to FIG. 4, showing a fourth embodiment; and

FIG. 8 is a plan view of a release sheet, showing a fifth embodiment.

### DETAILED DESCRIPTION

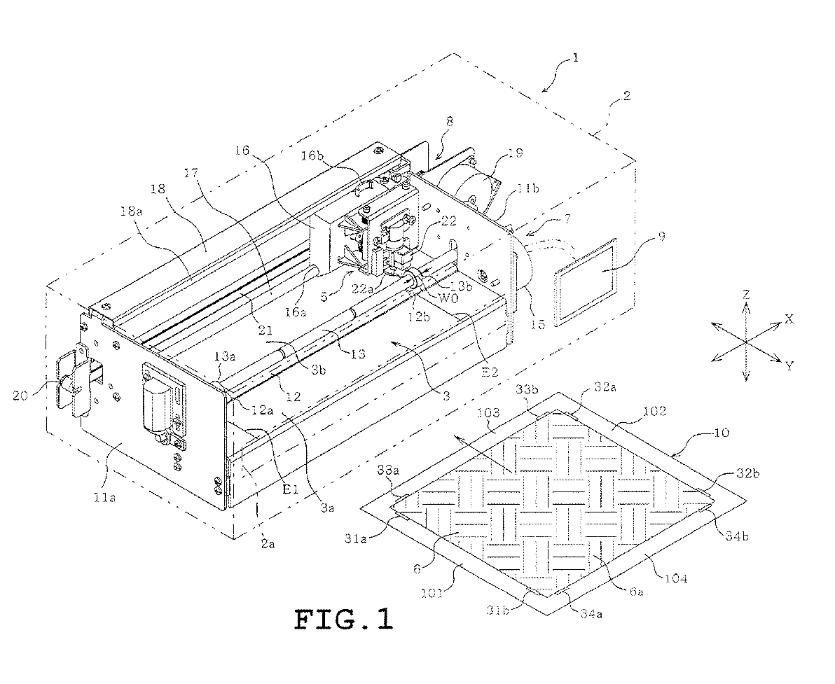

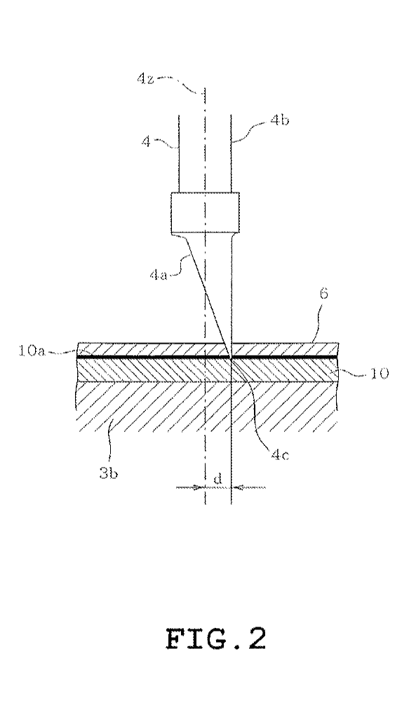

A first embodiment will be described with reference to FIGS. 1 to 4B. Referring to FIG. 1, a cutting apparatus 1 includes a body cover 2 as a housing, a platen 3 provided in the body cover 2 and a cutter holder 5 also provided in the body cover 2. The cutting apparatus 1 also includes first and second moving units 7 and 8 for moving a cutter 4 (see FIG. 2) held by the cutter holder 5 and an object 6 to be cut, relative to each other. The body cover 2 is formed into the shape of a horizontally long rectangular box and has a front formed with a horizontally long opening 2a which is provided for setting a holding sheet 10 holding the object 6 onto an upper surface of the platen 3. In the following description, a direction in which the object 6 is moved by the first moving unit 7 will be referred to as “front-back direction” and more specifically, the side of the cutting apparatus 1 where the opening 2a is located will be referred to as “front” and the opposite side will be referred to as “back.” The front-back direction will be referred to as “Y direction.” The right-left direction perpendicular to the Y direction will be referred to as “X direction.”

On a right part of the body cover 2 are provided a liquid crystal display (LCD) 9 and a plurality of operation switches (not shown). The LCD 9 serves as a display unit displaying messages and the like necessary for the user. The operation switches serve as input units for the user to supply various instructions, selections and inputs to the cutting apparatus 1.

The platen 3 includes a pair of front and rear plate members 3a and 3b and has the upper surface which is configured into an X-Y plane serving as a horizontal plane. The holding sheet 10 holding the object 6 is configured to be set so as to be placed on the platen 3. The holding sheet 10 is received by the platen 3 when the object 6 is cut. The holding sheet 10 has an upper surface with an adhesive portion 10a formed by applying an adhesive agent to an inside area thereof except for peripheral portions 101 to 104. The object 6 is affixed to the adhesive portion 10a thereby to be held.

The front plate member 3a of the platen 3 is provided with a pair of right and left positioning lines E2 and E1 for positioning the holding sheet 10 in the X direction (the right-left direction). A distance between the positioning lines E1 and E2 is set to be substantially equal to or slightly larger than a width of the holding sheet 10 in the right-left direction. The user can view the positioning lines E1 and E2 through the opening 2a. Accordingly, the positioning lines E1 and E2 serve as marks to position the holding sheet 10 widthwise or in the X direction.

The first moving unit 7 moves the holding sheet 10 on the upper surface side of the platen 3 in the Y direction (a first direction). More specifically, a driving roller 12 and a pinch roller 13 are mounted on right and left sidewalls 11b and 11a so as to be located between the plate members 3a and 3b of the platen 3. The driving roller 12 and the pinch roller 13 extend in the X direction and are rotatably supported on the sidewalls 11b and 11a. The driving roller 12 and the pinch roller 13 are disposed one above the other so as to be parallel to the X-Y plane. The driving roller 12 is located at the platen 3 side (the lower side) relative to the holding sheet 10 to be set. The pinch roller 13 located above the driving roller 12 is biased to the driving roller 12 side by spring means (not shown). The pinch roller 13 is provided with two pressing portions 13a and 13b which are brought into contact with both right and left peripheral portions 102 and 101 of the holding sheet 10, thereby pressing the peripheral portions 102 and 101, respectively. Each pressing portion has a slightly larger outer diameter than the other portion of the pinch roller 13. The pressing portions 13a and 13b have respective outer circumferential surfaces which are knurled. The driving roller 12 also has two pressing portions 12a and 12b which are located so as to correspond to the pressing portions 13a and 13b of the pinch roller 13 and which are knurled, respectively.

On the outer surface of the right sidewall 11b are mounted a Y-axis motor 15 and a first reduction gear mechanism (not shown) both to drive the driving roller 12. The driving roller 12 and the pinch roller 13 press the holding sheet 10 front below and from above by the biasing force of the spring means thereby to hold the holding sheet 10 therebetween, upon drive of the Y-axis motor 15, normal or reverse rotation of the Y-axis motor 15 is transmitted via the first reduction gear mechanism to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism, the spring means and the like.

The second moving unit 8 moves a carriage 16 supporting the cutter holder 5 in the X direction (a second direction). The second moving unit 8 will be described in more detail. A guide shaft 17 and a guide frame 18 both extending in the right-left direction are provided between the right and left sidewalls 11b and 11a so as to be located at the rear end of the cutting apparatus 1. The guide shaft 17 located right above the platen 3 extends through a hole of a lower part of the carriage 16 (a through hole 16a as will be described later). The guide frame 18 is fixed to upper ends of the sidewalls 11a and 11b by screws 21c respectively. The guide frame 18 has a front edge 18a which is folded downward to guide an upper part (a guided member 16b as will be described later) of the carriage 16.

On the outer surface of a rear part of the right sidewall lib are mounted an X-axis motor 19 and a second reduction gear mechanism (not shown). The second reduction gear mechanism is provided with a pulley. Another pulley 20 is rotatably mounted on an outer surface of the left sidewall 11a. An endless timing belt 21 connected to a rear end (a mounting portion as will be described later) of the carriage 16 extends between the pulley of the second reduction gear mechanism and the pulley 20.

Upon drive of the X-axis motor 26, normal or reverse rotation of the X-axis motor 26 is transmitted via the second reduction gear mechanism and the pulley to the timing belt 21, whereby the carriage 16 is moved leftward or rightward together with the cutter holder 5. Thus, the carriage 1.6 and the cutter holder 5 are moved in the X direction perpendicular to the Y direction in which the object 6 is conveyed. The second moving unit 8 is constituted by the above-described guide shaft 17, the guide frame 18, the X-axis motor 19, the second reduction gear mechanism, the timing belt 21, the carriage 16 and the like.

The cutter holder 5 is disposed on the front of the carriage 16 and is supported so as to be movable in a vertical direction (a third direction) serving as a 2 direction. The carriage 16 has a top formed, with a pair of guided members 16b between which a front edge 18a of the guide frame 1.8, although only one of the paired guided members 16b is shown in FIG. 1. The carriage 16 has a lower end formed with a through hole through which a guide shaft 17 is inserted. The carriage 16 further has a bottom wall on which a mounting portion (not shown) is formed so as to protrude rearward. The mounting portion is adapted to be connected to the timing belt 21. The carriage 16 is thus supported by the guide shaft 17 inserted through the through hole 16a so as to be slidable in the right-left direction and is further supported by the guide frame 18 held between the guided members 16b so as to be prevented from rotation about the guide shaft 17.

A Z-axis motor is disposed in the carriage 16 and a third reduction mechanism is provided between the carriage 16 and the cutter holder 5, although neither shown. The third reduction mechanism is a transmission mechanism which reduces rotational movement of the Z-axis motor and converts to and transmits vertical movement of the cutter holder 5. Upon drive of the Z-axis motor, normal or reverse rotation of the Z-axis motor is converted by the transmission mechanism to the vertical movement, whereby the cutter holder 5 is moved to a raised position and a lowered position together with the cutter 4. The above-described third moving unit which moves the cutter holder 5 to the raised or lowered position is thus constituted by the transmission mechanism and the Z-axis motor.

The cutter holder 5 includes a cutter shaft 4b (see FIG. 2) which is directed in the Z-axis direction and supported by bearings (not shown) so as to be rotatable about an axis 4z. In more detail, the cutter 4 has the round bar-shaped cutter shaft 4b and a blade 4a formed integrally on a lower end of the cutter shaft 4b. The blade 4a is formed into a substantially triangular shape and has a lowermost blade edge 4c located so as to be shifted from the central axis 4z of the cutter shaft 4b by a distance d, as shown in FIG. 2. Thus, the blade edge 4c of the cutter 4 is pressed against the X-Y plane or the surface of the object 6 from the Z-direction perpendicular to the X-Y plane. Furthermore, the cutter 4 has a height that is set so that when the cutter holder 5 has been moved to the lowered position, the blade edge 4c passes through the object 6 on the holding sheet 10 but does not reach the upper surface of the plate member 3b of the platen 3, as shown in WIG. 2. On the other hand, the blade edge 4c is also moved upward with movement of the cutter holder 3 to the raised position thereby to be separated from the object 6.

The cutter holder 5 is provided with a pressing device 22 pressing the object 6. The pressing device 22 includes a solenoid mounted on the cutter holder so as to be directed downward and a pressing member 22a which is brought into contact with the object around the blade 4a, although not shown in detail. When the solenoid is driven with the cutter holder 5 assuming the lowered position, the pressing member 22a is moved downward together with the plunger thereby to press the object 6 by a predetermined pressure. On the other hand, the plunger is located above during non-drive of the solenoid during non-drive of the solenoid, whereupon the pressing member 22a releases the object 6 from application of pressing force.

A control unit controlling the entire cutting apparatus 1 executes a cutting control program based on cutting data, thereby controlling the Y-axis motor 15, the X-axis motor 19, the Z-axis motor, the solenoid and the like so that the object 6 on the holding sheet 10 is automatically cut.

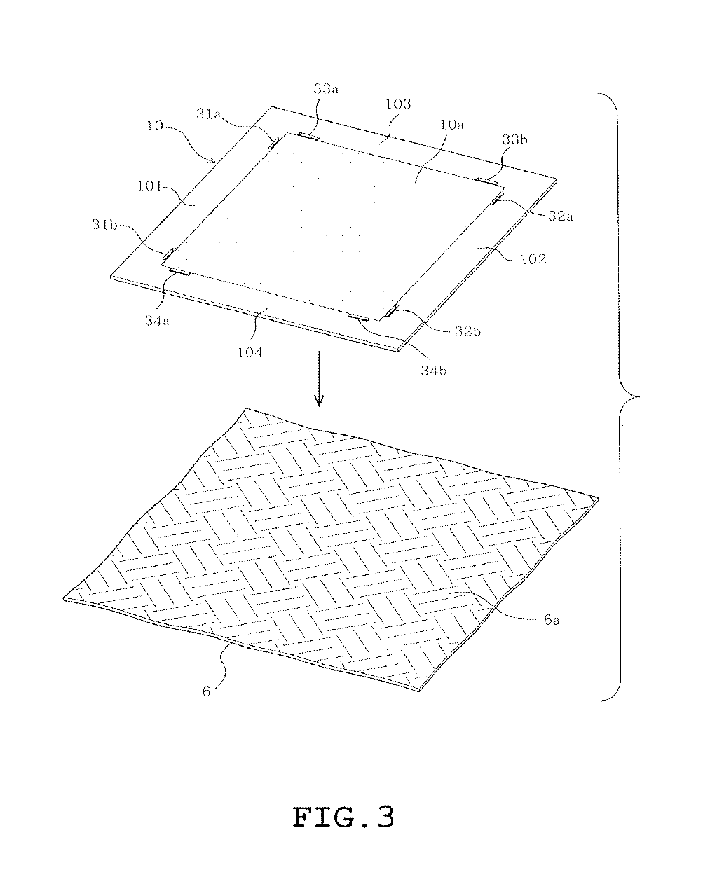

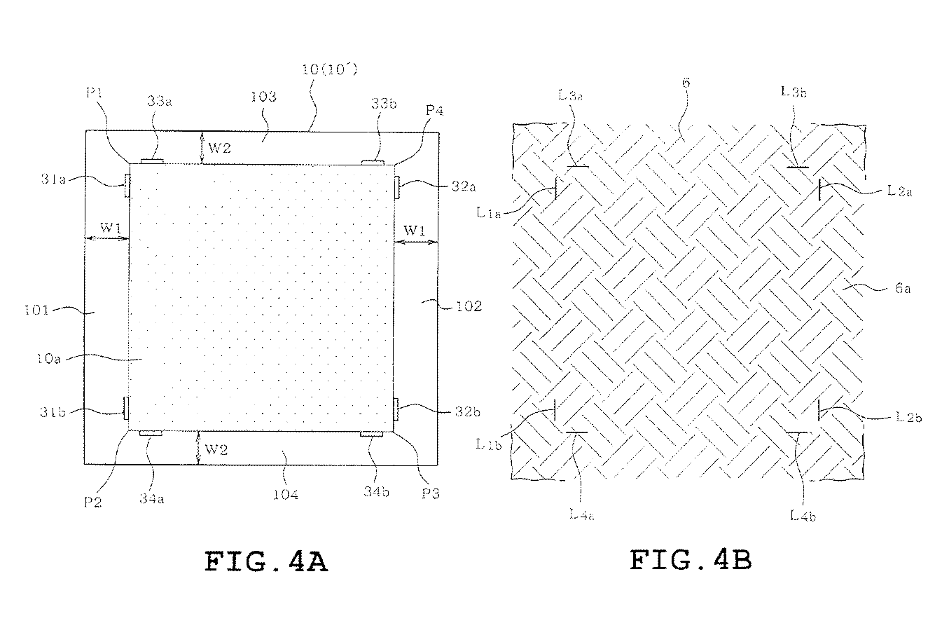

The object 6 may include various types of sheet materials including paper, cloth and resin films. Furthermore, even when the prepared object 6 is larger than the holding sheet 10, the object 6 can be matched to an appropriate size using the holding sheet 10. The configuration of the holding sheet 10 will now be described with further reference to FIGS. 3 and 4A. The holding sheet 10 serving as a holding member is a substantially square flat plate member in planar view as shown in FIG. 4A. The holding sheet 10 is formed of a sheet member 10′ which is a transparent resin material with relatively higher strength and stiffness, such as polypropylene. The holding sheet 10 has a transparent adhesive portion 10a on a side opposed, to the cutter 4 or an upper surface.

The adhesive portion 10a is formed in an area of the holding sheet 10 (the sheet member 10′) located a predetermined distance inside an outer edge of the holding sheet 10 (see widths W1 and W2 in FIG. 4A). The adhesive portion 10a is formed into a generally square shape, in planar view. The adhesive portion 10a is an adhesive layer (see FIG. 2) formed of a transparent material having a predetermined adhesion and is configured to removably hold, various types of objects 6. Furthermore, the adhesive portion 10a has an adhesion set to such a small value that the object 6 can easily be removed from the adhesive portion 10a without being broken. The forming region and shape of the adhesive portion 10a should not be limited to the aforementioned rectangular shape (inclusive of a square shape). The holding sheet 10 may include an A4-size rectangular adhesive portion and may be formed into a rectangular shape wider than the adhesive portion.

The holding sheet 10 has a periphery including a left peripheral portion 101, a right peripheral portion 102, a rear peripheral portion 103 and a front peripheral portion 104 none of which are provided with the adhesive portion 10a. The right and left peripheral portions 102 and 101 serve as supported portions which are vertically held between the driving roller 12 and the pinch roller 13 thereby to be supported. The right and left peripheral portions 102 and 101 have respective widths W1 that are set to be slightly larger than widths W0 of the respective pressing portions 13a and 13b of the pinch roller 13 (W1>W0). The rear and front peripheral portions 103 and 104 have respective widths W2 that are set to be substantially equal to the widths W1 of the right and left peripheral portions 102 and 101.

The holding sheet 10 (the sheet member 10′) has a plurality of holes 31a, 31b, 32a, 32b, 33a, 33b, 34a and 34b all of which are located so as to encompass the adhesive portion 10a. In more detail, a pair of elongate holes 31a and 31b are formed in the left peripheral part 101 so as to each extend lengthwise with respect to the left peripheral portion 101 (in the front-back direction). A pair of elongate holes 32a and 32b are formed in the right peripheral portion 102 so as to extend in the same direction as the holes 31a and 31b. A pair of elongate holes 33a and 33b are formed in the rear peripheral portion 103 so as to extend lengthwise with respect to the rear peripheral portion 103 (in the right-left direction). A pair of elongate holes 34a and 34b are formed in the front peripheral portion 103 so as to extend in the same direction as the holes 33a and 33b. The elongate holes 31a to 34b are located immediately outside the adhesive portion 10a so as to surround the adhesive portion 10a. The holes 31a to 34b are formed through the holding sheet 10 in the direction of a thickness thereof and are each formed along the periphery of the adhesive portion 10a into a slit shape.

The holes 31a to 34b are located near the corners of the adhesive portion 10a and more specifically, on the periphery of the adhesive portion 10a except for corners P1 to P4 of the adhesive portion 10a. In more detail, the holes 31a and 33a extend in two directions perpendicular to each other near the corner P1 of the adhesive portion 10a and are spaced from the corner P1 so as to be non-continuous to each other. In a similar manner, the holes 31b and 34a, the holes 34b and 32b, and the holes 32a and 33b all located near the other corners P2 to P4 are spaced from the corners P2 to P4 so that each paired holes are non-continuous to each other, respectively. As a result, local strength drop on the corners P1 to P4 can be suppressed in the holding sheet 10 having the holes 31a to 34b near the corners P1 to P4.

The above-described holding sheet 10 will work as follows. Paper with a hatched pattern 6a printed thereon will be used as the object 6 in the following description, as exemplified in FIG. 3. When paper prepared as the object 6 to be cut by the cutting apparatus 1 is so large that the paper runs off the edge of the adhesive portion 10a, the size of the paper is matched in the following manner. Firstly, the holding sheet 10 is put onto the object 6 from above. In this case, the hatched pattern 6a side of the object 6 is the top and the adhesive portion 10a side of the holding sheet 10 is also the top. Since the holding sheet 10 and the adhesive portion 10a are formed of the respective transparent materials, the lower object 6 and the hatched pattern can be seen through. Accordingly, the user adjusts the position of the holding sheet 10 so that a desired area of the object 6 is encompassed by the holes 31a to 34b, while viewing the peripheral edge of the object 6 and the hatched pattern 6a without turning over the holding sheet 10.

After having positioned the holding sheer. 10 relative to the object 6, the user puts a writing means such as air-soluble marker or ballpoint pen into the holes 31a to 34b and moves the writing means along the holes 31a to 34b, thereby drawing lines on the object 6. As a result, the object 6 is formed with eight short lines L1a to L4b corresponding to the respective holes 31a to 34b. The lines L1a to L4b serve as reference lines which peg out the respective corners of the square corresponding to the adhesive portion 10a. Based on the reference lines, the user cuts the object 6 along lines obtained by connecting the lines L1a and L1b, the lines L2a and L2b, the lines L3a and L3b and the lines L4a and L4b and drawing out the connected lines. As a result, the square object 6 matched to the adhesive portion 10a in size can be cut out.

The user then, affixes the cut-out object 6 to the adhesive portion 10a so that the object 6 is held by the holding sheet 10. In this case, the object 6 is positioned by placing the peripheral edge of the object 6 along the peripheral edge of the adhesive portion 10a so that the object 6 is prevented from protruding outside the adhesive portion 10a, whereupon the object 6 can suitably be affixed to the adhesive portion 10a. The user inserts the holding sheet 10 with the object 6 into the opening 2a of the cutting apparatus 1 to set the holding sheet 10 in the cutting apparatus 1. In this case, the user moves the holding sheet 10 rearward (in the direction of arrow in FIG. 1) while causing the right and left direction position to correspond with the positioning lines E1 and E2. The user then inserts the right and left edges of the holding sheet 10 between the pressing portions 12b and 13b and 12a and 13a of the driving roller 12 and the pinch roller 13.

Upon completion of the setting of the object 6 held by the holding sheet 10, the user operates the operation switches to select a desired one of cutting data stored on the storage device provided in the cutting apparatus 1, so that the cutting operation is executed. The object 6 is set to a suitable size as described above and is affixed to the holding sheet 10 so that the right and left edges 102 and 101 are prevented from protruding toward the right and left peripheral portions 102 and 101. Accordingly, the object 6 can be prevented from being rolled together by the pinch roller 13 or the like at the peripheral portions 101 and 102 of the holding sheet 10, and the holding sheet 10 can be moved stably irrespective of the thickness of the object 6.

The holding sheet 10 configured as described above includes the adhesive portion 10a which is formed on the area thereof located a predetermined distance W1 or W2 inside the peripheral edge of the sheet member and which holds the adhesive portion 10a holding the object 6 so that the object 6 is removable therefrom. The holding sheet 10 is provided with the plural holes 31a to 34b which are located so as to encompass the adhesive portion 10a.

According to the above-described configuration, in the case where the object 6 is larger than the area of the adhesive portion 10a when the holding sheet 10 is placed on the object 6, the object 6 can be viewed through the plural holes of the holding sheet 10. Accordingly, when marks are affixed through the holes of the holding sheet 10 to the object 6 with the pen, the marks serve as indexes that are sized to encompass the adhesive portion 10a. As a result, the object 6 can easily be matched to the size of the adhesive portion 10a while the size of the holding sheet 10 need not be measured. Consequently, various types of objects 6 can each be matched to a suitable size using the holding sheet 10, and the cutting apparatus 1 can execute a desirable cutting operation.

The adhesive portion 10a is configured to form the rectangular area, and the holes are located near the corners of the rectangular adhesive portion 10a. According to this configuration, the object 6 can be matched to the rectangular shape with the same size as the adhesive portion 10a and can suitably be affixed to the adhesive portion 10a. Furthermore, the marks necessary and enough to serve as the indexes of the rectangular shape can be affixed to the object 6.

The slit-like elongate holes 31a to 34b are formed along the periphery of the adhesive portion 10a. Consequently, the object 6 can be marked with the line marks L1a to L4b along the holes 31a to 34b. Furthermore, the marks L1a to L4b with which the object 6 is marked are easily visible since the marks serve as indexes with respective suitable lengths.

The holes 31a to 34b are located on the periphery of the adhesive portion 10a except for the corners P1 to P4 of the adhesive portions 10a. Consequently, local strength drop on the corners P1 to P4 can be suppressed in the holding sheet 10 having the holes 31a to 34b near the corners P1 to P4, whereupon the holding sheet 10 can be prevented from deformation and/or breakage.

Each of the holding sheet 10 and the adhesive portion 10a is formed of the transparent material. Consequently, the object 6 is visible through the holding sheet 10, and the holding sheet 10 can be positioned relative to the object 6 without being turned over. Furthermore, for example, when the object 6 has the pattern 6a printed thereon, the pattern 6a is visible through the holding sheet 10. The holding sheet 10 can be positioned while the pattern 6a is being viewed.

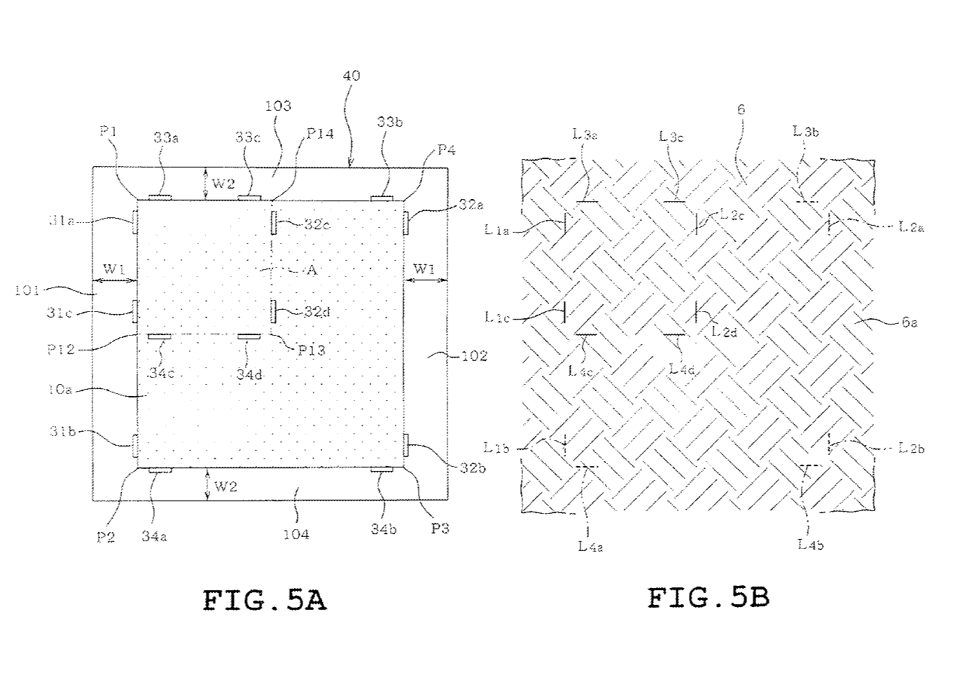

FIGS. 5A to 8 illustrate second to fifth embodiments. Similar or identical parts in the second to fifth embodiments are labeled by the same reference symbols as those in the first embodiment, and only the differences between each of the second to fifth embodiments and the first embodiment will be described.

FIGS. 5A and 5B illustrate the second embodiment. A holding sheet 40 according to the second embodiment differs from the holding sheet 10 in the following respects. More specifically, slit-like elongate holes 31c, 32c, 32d, 33c, 34c and 34d are additionally formed in the adhesive portion 10a so as to zone a left rear half area thereof. Of these holes, the holes 32c and 32d are formed substantially in the middle in the right-left direction so as to extend in the front-back direction, thereby dividing the rear half of the adhesive portion 10a into two areas. The holes 34c and 346 are formed substantially in the middle in the front-back direction so as to extend in the right-left direction, thereby dividing the left half of the adhesive portion 10a into two areas. As a result, the holes 32c, 32d, 34c and 34d are disposed so as to define the left rear half of the adhesive portion 10a into a rectangular (square) shape A as shown by two imaginary lines (see two-dot chain lines in FIG. 5A) extending in the directions of elongation of the holes 32c and 32d, and 34c and 34d immediately inside the holes 32c, 32d, 34c and 34d respectively. The holes 32c, 32d, 34c and 34d extend through the holding sheet 40 and a layer of the adhesive portion 10a in the thickness direction of the holding sheet 40 and the adhesive portion 10a.

The hole 31c of the left peripheral potion of the holding sheet 40 extends along the left peripheral portion in the front-back direction in the same manner as the holes 31a and 31b. The hole 33c of the rear peripheral portion 103 extends along the rear peripheral portion of the adhesive portion 10a in the right-left direction in the same manner as the holes 33a and 33b. The holes 31c and 33c extend through the holding sheet 40 in the thickness direction and constitute the holes (which will hereinafter be designated by symbols 31a to 34d) for the rectangular shape A together with the other holes 31a, 32c, 32d, 33a, 34c and 34d.

The rectangular shape A has corners P1, P12, P13 and P14 and four sides with respective lengths that are halves of those of corresponding sides of the adhesive portions 10a, as shown in FIG. 5A. In this case, the holes 31c and 34c extending in the directions perpendicular to each other near the corner P12 are formed so as to be separated from each other and accordingly discontinuous with each other. In a similar manner, the holes 34d and 32d and the holes 32c and 33c located near the corners P13 and P14 are formed so as to be separated from the corners 13 and 14 and accordingly discontinuous with each other, respectively. Consequently, local strength drop can be suppressed at each of the corners P1, P12, P13 and P14.

When a pattern to be cut on the basis of cutting data by the cutting apparatus 1 is smaller than the adhesive portion 10a, the user adjusts the size of the object 6 in the following manner. Firstly, the holding sheet 40 is placed on the object 6 from above in the same manner as in the first embodiment. The position of the holding sheet 40 is adjusted so that a desired area of the object 6 is encompassed by the holes 31a to 34d for the rectangular shape A. The user sequentially inserts the pen into the holes 31a to 34d to draw lines on the object 6. As a result, eight lines L1a, L1c, L2c, L2d, L3a, L3c, L4c and L4d corresponding to the respective holes 31a to 34d are imparted to the object 6, as shown by solid lines in FIG. 5B. The lines L1a to L4d are reference lines defining the corners of the aforementioned rectangular shape A. Based on the reference lines, the user extends the lines L1a and L1c, the lines L2c and L2d, the lines L3a and L3c, and the lines L4c and L4d in the respective lines and cut the object 6 along the extended lines. Consequently, the object 6 having the same size as the rectangular shape A of the holding sheet 40 can be cut out. The cut-out object 6 is applied to the adhesive portion 10a along the left rear edge of the adhesive portion 10a and set to the cutting apparatus 1 together with the holding sheet 40.

The holding sheet 40 thus has the holes 31a to 34d located so as to encompass the rectangular shape A which has one of the corners of the adhesive portion 10a common to the rectangular shape A and is smaller than the adhesive portion 10a. Consequently, the object 6 can easily be matched to the size of the rectangular shape suitable for the holding sheet 40 according to the size of the pattern to be cut by the cutting apparatus 1. In particular, when the pattern to be cut by the cutting apparatus 1 is relatively smaller, waste of the object 6 in the cutting can be reduced by matching the object 6 to the size of the rectangular shape A. Furthermore, since the holes 31a to 34d are located in the peripheral portion except for the corners P1, P12, P13 and P14 of the rectangular shape A, local strength drop on the corners P1 and P12-P14 can be suppressed in the holding sheet 40. Thus, the second embodiment can achieve the same advantages as achieved by the first embodiment.

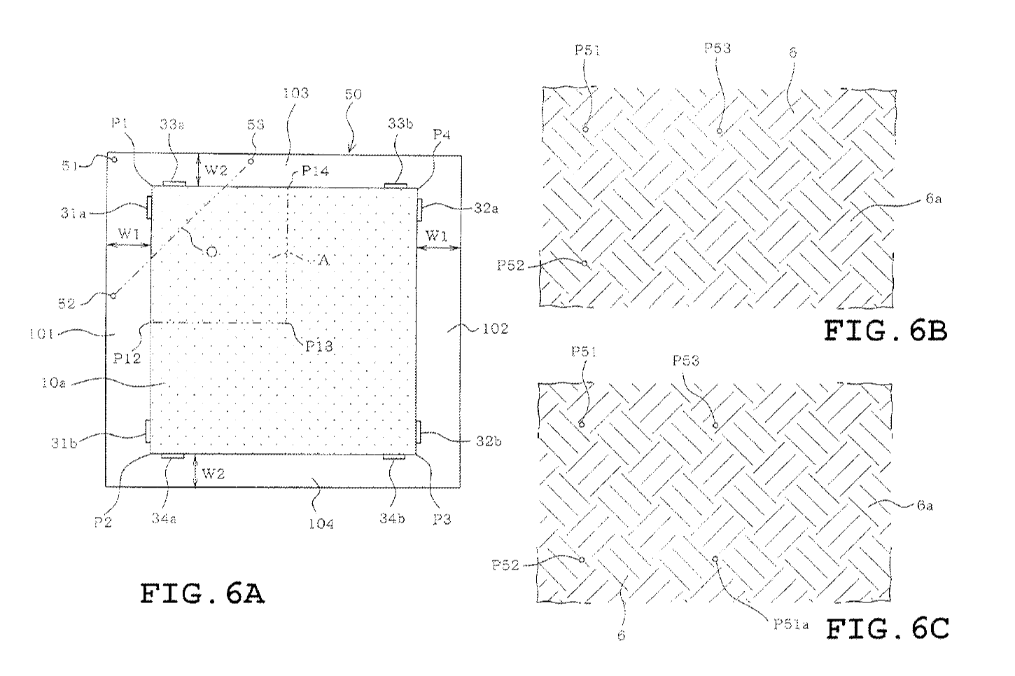

FIG. 6A illustrates a third embodiment, which differs from the first embodiment in the following. The holding sheet 50 has round holes 51, 52 and 53 corresponding to the corners P1, P12 and P14 of the rectangular shape A respectively as shown in FIG. 6A. The round holes 51-53 have diameters set to relatively smaller values and extend through the holding sheet 50 in the thickness direction thereof. Furthermore, the round holes 51-53 are formed so as to be spaced outward from the outer edge of the adhesive portion 10a in the peripheral portions 101 and 103. A distance between the round holes 51 and 52 is set to be equal to the distance between the corners P1 and P12. A distance between the round holes 51 and 53 is set to be equal to the distance between the corners P1 and P14.

In the holding sheet 50, the object 6 can be matched to the same size as the rectangular shape A by the three round holes 51 to 53. In this case, firstly, the holding sheet 50 is placed on the object 6 from above in the same manner as described above. The position of the holding sheet 50 is adjusted so that a desired area of the object 6 is encompassed with the round holes 51 to 53 serving as guides. The user sequentially inserts the pan into the round holes 51 to 53 to draw round marks or dots on the object 6. As a result, three small marks P51, P52 and P53 corresponding to the respective round holes 51 to 53 are affixed to the object 6, as shown in FIG. 6B. When, the holding sheet 50 is then turned 180° on the object 6 about a middle point O of an imaginary line connecting between the round holes 52 and 53, the round marks P53 and F52 of the object 6 correspond with the round holes 52 and 53 of the holding sheet 50 respectively, as shown in FIG. 6A. In this state, the user can draw a round mark P51a through the round hole 51 of the holding sheet 50 onto the object 6, as shown in FIG. 6C.

In the third embodiment, the peripheral portions 101 and 103 of the holding sheet 50 are formed with the three round holes 51-53 which are spaced outward from the outer edge of the adhesive portion 10a and serve as holes corresponding to the rectangular shape A. Consequently, four round marks P51, P52, P51a and P53 are formed on the object 6 by the three holes 51-53 of the holding sheet 50. The user then cuts the object 6 along a line sequentially passing the four round marks P51 to P53 with scissors (not shown), whereby the object 6 can be matched to the size of the rectangular shape A smaller than the adhesive portion 10a. Moreover, since no holes are formed in the adhesive portion 10a, the blade edge of the cutter 4 can be prevented from being caught by the hole when the object 6 affixed to the adhesive portion 10a is cut by the cutting apparatus 1.

Furthermore, since the round holes 51 to 53 are formed in the holding sheet 50 so as to correspond to the respective corners of the rectangular shape A, the holes 51-53 can be rendered as small as possible. Still furthermore, the holes 51-53 formed into the round shape can suppress strength drop of the holding sheet 50 with the forming of the holes 51-53. The round holes as described above may be formed so as to correspond to the respective corners P1 to P4 in the holding sheet 10 of the first embodiment, instead of the elongate holes 31a to 34b, although not shown.

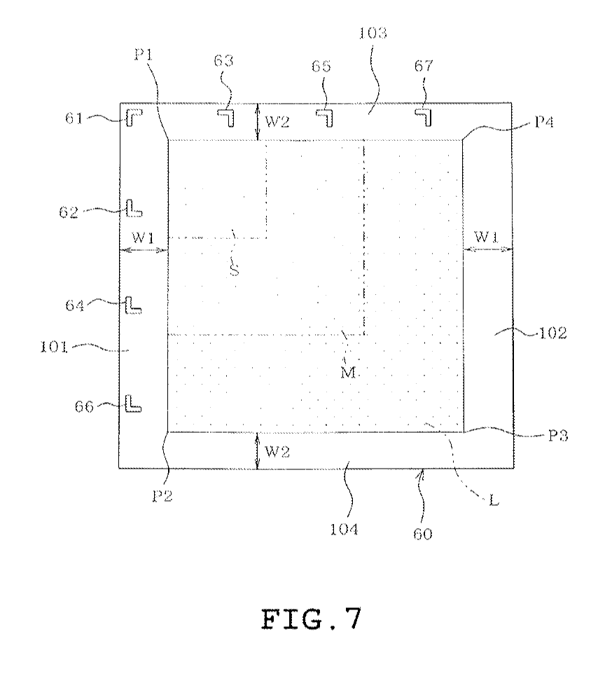

FIG. 7 shows a holding sheet 60 according to a fourth embodiment. The holding sheer 60 differs from the holding sheet 10 of the first embodiment in that a plurality of generally L-shaped holes 61 to 67 is formed while the holes 31a to 34d are eliminated.

The holes 61 to 67 are formed in the peripheral portions 101 and 103 so as to be spaced outward from the outer edge of the adhesive portion 10a. The holes 61, 62, 64 and 66 are formed along the left peripheral portion at regular intervals in the front-back direction. The holes 61, 63, 65 and 67 are formed along the rear peripheral portion of the adhesive portion 10a at regular intervals in the right-left direction. In this case, the holes 61 and 67 are set so as to correspond to the corners P1 and P4 respectively.

Accordingly, the holding sheet 60 is provided with three rectangular shapes S, M and L as shown in FIG. 7, that is, a small rectangular shape S formed using three holes 61, 62 and 63, a middle rectangular shape M formed using three holes 61, 64 and 65 and a large rectangular shape L formed using three holes 61, 66 and 67. The object 6 can be matched to one of the three rectangular shapes S, M and L. More specifically, the object 6 can be affixed with four marks corresponding to the corners of any one of the rectangular shapes S, M and L by making use of one of three hole groups, the holes 61, 62 and 63, the holes 61, 64 and 65 and the holes 61, 66 and 67. Since the above-described matching manner can be carried out in the same way as described in the third embodiment (see FIGS. 6B and 6C), the description of this manner will be eliminated.

In the fourth embodiment, the plural holes 61, 62, 64 and 66 are formed in the peripheral portion 101 of the holding sheet 60 at regular intervals along one of the paired perpendicular sides of the adhesive portion 10a. The plural holes 61, 63, 65 and 67 are also formed in the peripheral portion 103 of the holding sheet 60 at regular intervals along the other side of the adhesive portion 10a. Consequently, by suitably setting the number or the intervals of the holes 61-67, the object 6 can stepwise be matched to the size of one of the rectangular shapes according to the size of the pattern cut out of the object 6 by the cutting apparatus 1.

The holding sheets 10, 40, 50 and 60 of the first to fourth embodiments are provided with removable sheets (not shown) which cover the surfaces of the adhesive portions 10a respectively. The removable sheets protect the adhesive portions 10a so that the adhesive portions 10a are kept contactless, or dust or the like does not adhere to the adhesive portions 10a during non-use of the holding sheets 10 and 40-60, respectively. Bach removable sheet is formed of a transparent resin material with a suitable stiffness such as silicon-treated polyethylene terephthalate (PET). Each removable sheet is formed into a rectangular flat plate shape and has the same size as the adhesive portion 10a. Accordingly, the object 6 is visible through each one of the holding sheets 10, 40-60 even when the surface of the adhesive portion 10a is covered with the removable sheet. Furthermore, the user can affix marks with a pen without touching the adhesive portion 10a, whereby the holding sheet 10 can be rendered more convenient.

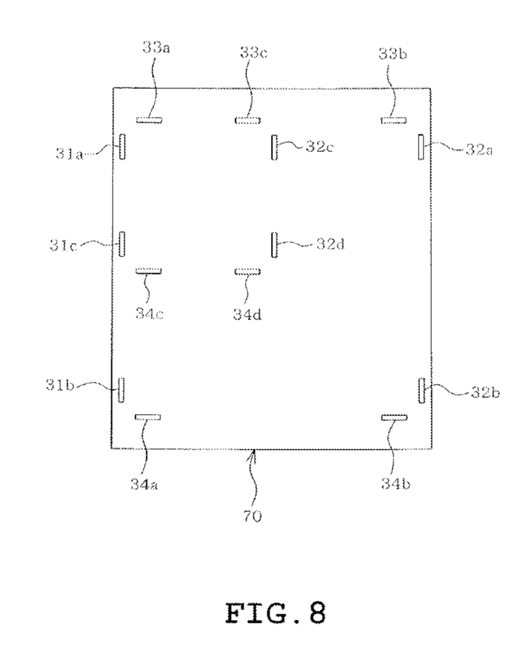

FIG. 8 illustrates a removable sheet 70 in a fifth embodiment. The removable sheet 70 is formed of the transparent resin material having such a stiffness that the flat plate shape can be maintained. The removable sheet 70 is formed to be larger than the adhesive portion 10a of the holding sheet (not shown). The holding sheet of the fifth embodiment has no holes such as described in the foregoing embodiments. However, the removable sheet 70 is formed with holes which are similar to those of the holding sheet 40 of the second embodiment. More specifically, the removable sheet 70 has the elongate holes 31a, 31b, 32a, 32b, 33a, 33b, 34a and 34b assuming positions corresponding to the positions where the adhesive portion 10a is encompassed, respectively. The removable sheet 70 also has the elongate holes 31c, 32c, 32d, 33c, 34c and 34d assuming positions corresponding to the positions where the rectangular shape A is encompassed.

The removable sheet 70 configured as described above is removed from the adhesive portion 10a, and the holding sheet is placed on the object 6. When the object 6 is larger than the adhesive portion 10a, marks are affixed to the object 6 with a pen through the holes 31a to 34d of the removable sheet 70 corresponding to the adhesive portion 10a. As a result, the object 6 can be matched to the size of the adhesive portion 10a using the removable sheet 70. On the other hand, when the pattern to be cut out by the cutting apparatus is relatively smaller, marks are affixed to the object 6 with a pen through the holes 31a to 34d of the removable sheet 70 corresponding to the rectangular shape A. As a result, the object 6 can easily be matched to the size of the rectangular shape A using the removable sheet 70.

The removable sheet 70 can maintain its original flatness without easy deformation by an external force since the removable sheet 70 is formed of a resin material which has a stiffness sufficient to maintain the flatness thereof. Accordingly, the marks can accurately be affixed to the object 6 with the removable sheet 70 serving as a template, whereby the removable sheet 70 can be rendered more convenient. Furthermore, since the removable sheet 70 is transparent, the object 6 is visible through the removable sheet 70 with the result that the removable sheet 70 can be positioned relative to the object 6 without being turned over.

The foregoing embodiments should not be restrictive but may be modified or expanded as follows. Although the cutting apparatus 1 serves as a cutting plotter in each foregoing embodiment, the cutting apparatus may be applied to various types of devices and apparatuses each provided with a cutting function.

The holes of the holding sheet should not be limited to the above-described shapes and arrangement manners. The holes may assume any positions encompassing the adhesive portion 10a or encompassing a predetermined area in the adhesive portion 10a (areas designated by symbols A, S, M and L, for example). Furthermore, the holes of the removable sheet may also assume positions corresponding to positions encompassing the adhesive portion 10a or corresponding to positions encompassing a predetermined area in the adhesive portion 10a. Accordingly, the removable sheet may selectively be formed with holes similar to various types of holes shown in the first to fourth embodiments.

The above-described holding sheet, the adhesive portion and the removable sheet may be formed of an opaque material, instead. In this case, although the object 6 is not visible through the holding sheet, the adhesive portion and the removable sheet, the holding sheet or the removable sheet may be placed on the object 6 and positioned while the object 6 is viewed through the holes of the holding sheet or the removable sheet. Marks can be affixed through the holes to the object 6 with a pen.

The holding sheet or the removable sheet may be formed into any shape other than the rectangular shape. Furthermore, the adhesive portion 10a may be formed over an entire upper surface of the holding sheet. In this case, when thin plate members made of a metal or resin are affixed to portions corresponding to the right and left peripheral, portions 101 and 102, these portions can serve as supported portions, respectively.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A holding sheet which is set to a cutting apparatus cutting an object to be cut, comprising:
a sheet member comprising a flat plate-shaped member; and
an adhesive portion provided on an area of the sheet member located a predetermined distance inside an outer edge of the sheet member, the adhesive portion holding the object so that the object is removable therefrom,
wherein the sheet member has a plurality of holes which is formed therethrough so as to encompass the adhesive portion.

2. The holding sheet according to claim 1, wherein the adhesive portion is provided so as to form a rectangular area, and the holes are located near corners of the rectangular adhesive portion.

3. The holding sheet according to claim 2, wherein the holes are elongate holes formed along a periphery of the adhesive portion into a slit shape.

4. The holding sheet according to claim 3, wherein the elongate holes are located in the periphery of the holding sheet except for corners of the rectangular adhesive portion.

5. The holding sheet according to claim 2, wherein the holes are located at the corners of the rectangular adhesive portion.

6. The holding sheet according to claim 1, wherein each of the sheet member and the adhesive portion is formed of a transparent material.

7. The holding sheet according to claim 6, further comprising a removable sheet covering a surface of the adhesive portion, wherein the removable sheet is formed of a transparent material.

8. A holding sheet which is set to a cutting apparatus cutting an object to be cut, comprising:
a sheet member comprising a flat plate-shaped member;
an adhesive portion provided on an area of the sheet member located a predetermined distance inside an outer edge of the sheet member, the adhesive portion holding the object so that the object is removable therefrom; and
a removable sheet which is formed into a flat plate shape and covers a substantially entire surface of the adhesive portion, the removable sheet being larger than an area of the adhesive portion, the removable sheet having a plurality of holes which is formed therethrough so as to encompass the adhesive portion.

9. The holding sheet according to claim 8, wherein the removable sheet, is formed of a resin material which has a stiffness sufficient to maintain a flatness thereof.

10. A cutting apparatus which includes a cutting blade cutting an object to be cut, comprising:
a holding sheet settable to the cutting apparatus, the holding sheet including:
a sheet member comprising a flat, plate-shaped member; and
an adhesive portion provided on an area of the sheet member located a predetermined distance inside an outer edge of the sheet member, the adhesive portion holding the object so that the object is removable therefrom,
wherein the sheet member has a plurality of holes which is formed therethrough so as to encompass the adhesive portion.
